(19) United States
(12) Patent Application Publication
(10) Pub. No.: US 2024/0010021 A1
(43) Pub. Date: Jan. 11, 2024

(54) Flexographically-Printable, Full-Color-Inkjet-Receptive Topcoat Formula and Article

(71) Applicant: Brady Worldwide, Inc., Miwaukee, WI (US)

(72) Inventors: Brandon J. Adkins, Shorewood, WI (US); Timothy W. Shay, Milwaukee, WI (US); Brian J. Fraleigh, New Berlin, WI (US)

(21) Appl. No.: 18/265,197

(22) PCT Filed: Dec. 9, 2021
(86) PCT No.: PCT/US2021/062547

§ 371 Date: Jun. 2, 2023

Related U.S. Application Data
(60) Provisional application No. 63/128,470, filed on Dec. 21, 2020.

(51) Int. Cl. B41M 5/50; B32B 7/06; B32B 27/36; B32B 7/12; B32B 27/10; B41F 5/24; C09D 11/54; C09D 11/322; C09D 11/38; C09D 11/037; C09D 11/106; G09F 3/02; G09F 3/10

(52) U.S. Cl. CPC B41M 5/502; B32B 7/06; B32B 27/36; B32B 7/12; B32B 27/10; B41F 5/24; C09D 11/54; C09D 11/322; C09D 11/38; C09D 11/037; C09D 11/106; G09F 3/02; G09F 3/10; B32B 2255/26; B32B 2255/12; B32B 2255/28; B32B 2307/75; B32B 2307/4023; B32B 2255/10; B32B 2307/41; B32B 2307/412; B32B 2519/00; G09F 2003/0202; G09F 2003/0225; G09F 2003/0257

(57) ABSTRACT

A full-color-inkjet receptive topcoat can be flexographically printed on a substrate. The flexographically-printed, full-color-inkjet receptive topcoat includes a pigment and a polymeric binder, in which a ratio of the pigment to polymeric binder is in a range of from 3:1 to 5:1 by dry parts. Such a coating provides good printability with color inkjet printing, which conventionally has not been possible with flexographically-printed topcoats.

### CROSS-REFERENCE TO RELATED APPLICATIONS

This application claims the benefit of U.S. Provisional Patent Application No. 63/128,470 entitled “Flexographically-Printable, Full-Color-Inkjet-Receptive Topcoat Formula and Article” filed on Dec. 21, 2020, which is incorporated by reference herein for all purposes.

### BACKGROUND

This disclosure relates to an inkjet-receptive coating or topcoat for substrates and, in particular, to a flexographically-printable, full-color-inkjet receptive topcoat.

Flexography involves the application of a material to a surface by a flexible relief plate, typically made of rubber or some other elastomeric material. Most commonly, flexography has been used as a printing process for application of inks to paper. However, flexography also has been used to a very limited degree in other applications such as in the application of coatings to substrates, albeit with continued technical difficulty and qualified results. To wit, while flexography is sometimes listed as an acceptable coating method in the literature for inkjet-receptive coatings specifically, in actuality and to date, very few inkjet coatings are flexographically printed. This is the case as, generally, functional inkjet-receptive coatings are deposited at coat weights around and exceeding 16 lb/ream (26.048 grams per square meter (GSM)), which is an amount that is much higher than the approximately 1 lb/ream (1.628 GSM) conventionally deposited via flexographic processes.

Accordingly, in practice, the printing of an inkjet-receptive topcoat flexographically is quite atypical and has presented limitations in usage. For example, the dry time of a printed inkjet image suffers when such inkjet-receptive coatings are flexographically deposited. This slow dry time makes the printed image susceptible to smearing as shown in FIGS. 1A-1C in which images and colors have been printed on flexographically applied coatings and then subjected to smear tests.

### SUMMARY

Within the small subset of inkjet coatings that are actually flexographically printed, no such coating is believed to provide full-color inkjet ink compatibility with sufficient print quality. That is to say, such formulated coatings have not been able to have an instantaneously dry image, limited-inter color bleed and mottle, high optical density, and so forth. As an example, Brady Corporation of Milwaukee, WI produces a JetTab Series Self-Laminating Vinyl Labels (B-117) that includes an inkjet-receptive topcoat that is flexographically printed. However, this product is compatible with black ink only, minimizing one of the most important advantages of inkjet printing: full-color, print-on-demand capabilities. The lack of full-color capability results from insufficient absorptivity of the product. Printing of monocolor black requires 100% ink coverage and the product is capable of such levels of absorptivity. However, tricolor cartridges may apply up to 300% ink coverage, given that the three inks may be applied upon one another, which requires greater absorptivity than that product provides and so accordingly the product is not capable of robustly receiving tricolor ink. The poor image quality of B-117 printed on a BradyJet J2000 using cyan-magenta-yellow (CMY) inks can be seen in FIG. 2 as compared to black ink. Thus, there remains a strong, but yet unmet need, for flexographically-printable, full-color-inkjet receptive topcoats.

Disclosed herein is an inkjet-receptive coating or topcoat and a respective substrate to which the coating is applied, specifically via flexography, to form an article. The coating and its formulation are such that it imparts optimal inkjet receptivity to the substrate (including color density, dry time, print quality, and so forth) even when deposited at the minimal coat-weights yielded by flexographically printing.

According to one aspect, an article with a flexographically-printed, full-color-inkjet receptive topcoat is provided. The article includes a substrate and a flexographically-printed, full-color-inkjet receptive topcoat that is flexographically applied on a side of the substrate. The flexographically-printed, full-color-inkjet receptive topcoat includes a pigment and a polymeric binder in which a ratio of the pigment to polymeric binder is in a range of from 3:1 to 5:1 by dry parts.

In some forms, the ratio of the pigment to polymeric binder may be in a range of from 7:2 to 9:2 by dry parts, or targeted to 4:1 by dry parts.

In some forms, a side of the substrate may have an adhesive layer received thereon with that side being opposite the side of the substrate on which the flexographically-printed, full-color-inkjet receptive topcoat is flexographically applied. In such form, the article may further include a liner covering the adhesive in which, for example, the liner can be removed to expose the adhesive such that the article may be used as a label. In some specific forms, the adhesive may be only on the side opposite the topcoat and may partially or fully cover that side.

In some forms, the article may further include a printed image in color ink thereon printed by an inkjet printer.

In some forms, the article may further include an opaque white base layer on the side of the substrate between the substrate and the flexographically-printed, full-color-inkjet receptive topcoat. In some forms, this base layer may be ultraviolet-curable.

In some forms, the flexographically-printed, full-color-inkjet receptive topcoat may include one or more additives that may be a surfactant, an anti-settling additive, and/or an optical brightener. Likewise, either separately or in combination with one or more of those additives, in some forms, the article may further include a mordant in the flexographically-printed, full-color-inkjet receptive topcoat.

In some forms, the binder may be a blend of vinyl-acetate ethylene copolymer (VAE) and polyvinyl alcohol (PVA).

In some forms, the pigment may be selected from carbonate, kaolin, silica, titanium dioxide, silicates, and combinations thereof. The pigment may have primary particle sizes ranging from 100 nanometers (nm) to 10 micrometers (μm) and specific surface areas of from 150 m²/g to 750 m²/g.

In some forms, the substrate may be a polymeric substrate, such as, for example, a polyethylene terephthalate (PET) or a vinyl material.

In some forms, the flexographically-printed, full-color-inkjet receptive topcoat may be applied to the substrate in an amount less than 2.5 lb/ream (4.07 GSM).

In some forms, the article may be a self-laminating marker (i.e., a “self lam”) having a head end with a printable area and a tail end which is transparent. The flexographically-printed, full-color-inkjet receptive topcoat may be provided on at least on the printable area and the article may include an adhesive layer received on a side of the substrate opposite the side on which the flexographically-printed, full-color-inkjet receptive topcoat is flexographically applied. This adhesive can cover the entire side opposite the topcoat in some forms of the self-laminating marker although, in some other forms of self-laminating markers, the adhesive may cover only a fractional portion of the side opposite the inkjet-receptive topcoat. With such structure, during application of the self-laminating marker around an object by wrapping and after printing on the printable area, the head end can first wrap around the object until the tail end wraps back around to adhere to the self-laminating marker to itself to cover the printable area and protect the underlying printable area as well as any indicia or printing received thereon. In this way, the laminating tail end can increase durability by providing a barrier over the printing on the printable area of the head end of the self-laminating marker.

According to another aspect, a method of making an article is disclosed. A full-color-inkjet receptive topcoat is flexographically printing onto a side of a substrate. The full-color-inkjet receptive topcoat comprises a pigment and a polymeric binder in which a ratio of the pigment to polymeric binder is in a range of from 3:1 to 5:1 by dry parts (although may be more specifically targeted to be approximately 4:1).

In some forms of the method, the flexographically-printed, full-color-inkjet receptive topcoat may be printed or applied on the substrate in an amount less than 2.5 lb/ream (4.07 GSM).

According to yet another aspect, a flexographically-printable, full-color-inkjet receptive topcoat for flexographic application on a side of a substrate is provided. The flexographically-printable, full-color-inkjet receptive topcoat includes a pigment and a polymeric binder in which a ratio of the pigment to polymeric binder is in a range of from 3:1 to 5:1 by dry parts.

In some forms, the ratio of the pigment to polymeric binder may be in a range of from 7:2 to 9:2 by dry parts, or targeted to 4:1 by dry parts.

Again, in some forms, the flexographically-printable, full-color-inkjet receptive topcoat may further include one or more additives that can include a surfactant, an anti-settling additive, and/or an optical brightener. Still further in addition to those additives or separately, the flexographically-printable, full-color-inkjet receptive topcoat may further include a mordant in the flexographically-printable, full-color-inkjet receptive topcoat.

In some forms, the binder may include a blend of vinyl-acetate ethylene copolymer (VAE) and polyvinyl alcohol (PVA).

In some forms, the pigment may be carbonate, kaolin, silica, titanium dioxide, silicates, and combinations thereof. The pigment may have primary particle sizes ranging from 100 nm to 10 μm and specific surface areas of from 150 m²/g to 750 m²/g.

According to yet another aspect, a method of printing onto an article of the type described above is provided. The method includes printing a color ink onto the flexographically-printed, full-color-inkjet receptive topcoat using an inkjet printer.

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### DESCRIPTION OF THE DRAWINGS

FIGS. 1A, 1B, and 1C are photographs depicting image quality and the smearing of an inkjet-printed image on a conventional flexographically-applied coating in a Brady Corporation outdoor-durable product having a pigment to binder ratio of 1.15 (in FIG. 1A) and two competitive products (in FIGS. 1B and 1C) having unknown pigment to binder ratios.

FIG. 2 is a photograph depicting the poor image quality from color inkjet printing on a JetTab Series Self-Laminating Vinyl Labels (B-117) having a flexographically-applied topcoat in which the label is only compatible with black ink given the print quality issues with color printing.

FIGS. 3A and 3B are printed color images in a label having the new flexographically-printable, full-color-inkjet receptive topcoat in which mordant is not included in the topcoat (FIG. 3A) and in which mordant is included in the topcoat (FIG. 3B).

FIGS. 4A-4C are photographs depicting a number of labels having the flexographically-printable, full-color-inkjet receptive topcoat after chemical immersion and rubs.

FIG. 5 is a cross-sectional schematic depicting one embodiment of a label showing the various layers after the topcoat has been printed on and before the liner has been removed to expose the adhesive.

FIG. 6 is a top view of a schematic of a self-laminating label according to one embodiment in which the clear self-laminating portion of the label can be used to cover the part of the label having the printed image on the flexographically-printable, full-color-inkjet receptive topcoat to protect it after the label has been printed and dried.

FIG. 7 is a group of four photographs of printed labels having the flexographically-printable, full-color-inkjet receptive topcoat.

FIG. 8 is a photograph showing four such printed labels having the flexographically-printable, full-color-inkjet receptive topcoat in which the labels are applied to test tubes.

FIG. 9 is a photograph showing as—printed self-laminating labels in which the labels have the flexographically-printable, full-color-inkjet receptive topcoat, but before the labels have been applied to an object such as, for example, the test tubes of FIG. 8.

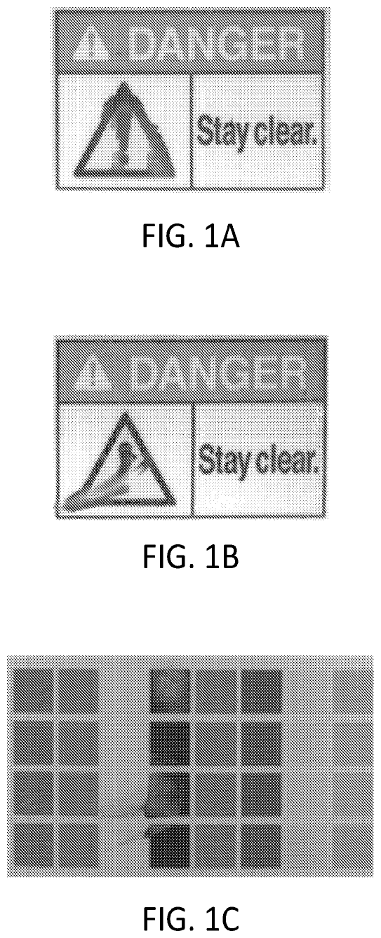

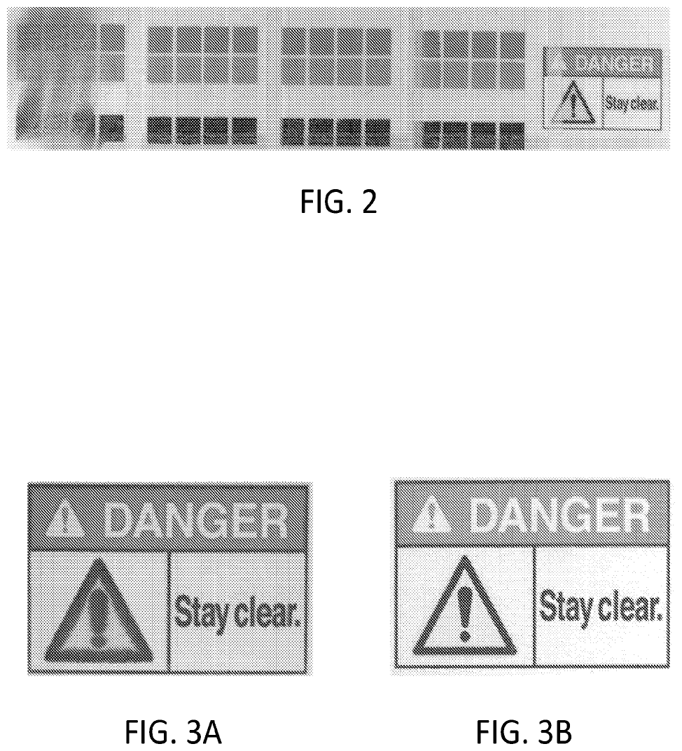

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings. Further, “connected” and “coupled” are not restricted to physical or mechanical connections or couplings.

The numerical ranges disclosed herein include all values from, and including, the lower and upper value. For ranged containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The figures, which are not necessarily to scale, depict selected embodiments and are not intended to limit the scope of embodiments of the invention. Skilled artisans will recognize the examples provided herein have many useful alternatives and fall within the scope of embodiments of the invention.

This disclosure relates to an inkjet-receptive coating, which may be referred to as a “topcoat,” and a respective substrate to which the coating is applied, specifically via flexography. The coating is designed in a manner that imparts optimal inkjet receptivity to the substrate (for example, in color density, dry time, print quality, and so forth) even when deposited at the minimal coat-weights yielded when flexographically printing.

The flexographically-printable, full-color-inkjet receptive topcoat disclosed herein utilizes a microporous design to absorb aqueous inkjet inks via capillary action. The disclosed topcoat includes an absorptive component (commonly known as the “pigment”) and any combination of polymeric resins (the “binder(s)”), and optionally one or more additives such as, for example, surfactants (although more possible additives are described herein and below).

The following paragraphs provide more detail around the components of the topcoat and article, their relationship to one another, and the functions of each raw material in this coating as well as in the constituent components of the substrate (and adhesive in the event the article is an adhesive label, for example) on which the coating is applied.

### Pigment

As used herein, a “pigment” is a visible light absorbing, scattering, refracting, or reflecting material or compound that is present in a non-molecularly dispersed (particulate) form.

The pigment of the topcoat can absorb the aqueous inkjet inks in a manner similar to a microscopic sponge. This pigment can be, but is not limited to, any of the following porous minerals: silica, titanium dioxide, calcium carbonate, kaolin, or various silicates and they may have, for example, but not limited to, primary particle sizes ranging from 100 nm to 10 μm and specific surface areas of from 150 m²/g to 750 m²/g.

Many physicochemical properties of the selected pigment can impact the quality of the printed inkjet image. A narrow, controlled particle-size distribution of the pigment can limit differential absorption of an aqueous inkjet ink, thereby limiting mottle in the printed image. Additionally, increased pigment pore volume and oil adsorption values yield a greater absorptive capacity, a quantity which can impact both dry time and color density of an inkjet-printed image. Lastly, the specific surface area of the pigment can impact the decision to be made with respect to many additive loading levels.

Coatings utilizing a pigment with a broad particle size distribution typically yield mottled (that is, non-uniform) printed images. In some forms, silica may be a preferred pigment relative to other potential pigments due to the ability of manufacturers to tightly control its particle size distribution, surface area, and pore size distribution. Dispersions of silica may be easily created and stabilized by conventional methods. In some forms, of the various types of silica (colloidal, fumed, precipitated), precipitated grades may be preferred due to their extremely high porosity, which may aid in absorption and drying of the large quantities of ink that are deposited by modern inkjet printers. These silica pigments are commercially available from Evonik (SIPERNAT, SPHERILEX), Grace Davidson (SYLOID), and PPG (LO-VEL), among others.

The particular pigment used in the exemplary embodiments was a precipitated silica, Syloid® W 300 (available from W. R. Grace and Company of Columbia, MD), which has an average particle size (i.e., a primary particle size) of 5.7 μm, a pore volume of 1.2 mL/g (in accordance with the GRACE Q 53 test method), an oil adsorption of 75 g/100 g silica, and a Brunauer-Emmett-Teller (BET) surface area of 270 m²/g. The loading level of the pigment can be significant in the proper functioning of this coating, especially relative to the binder concentration. The Syloid® W 300 was loaded at 72.7% of the dry coating in the example below. Lastly, this particular grade of silica is pre-wet to aid in its dispersability.

While Syloid® W 300 is described as being an exemplary pigment, it will be appreciated that many types of porous pigments exist and may be acceptable for use in inkjet-receptive coatings.

As mentioned elsewhere herein, pigment selection and pigment-loading levels can greatly impact to the performance of the coating. Notably, the coating described in this disclosure has a much higher pigment loading compared to other inkjet coatings. This increased pigment loading allows for optimal print quality and dry time using conventional aqueous cyan-magenta-yellow (CMY) inksets (for example, BradyJet J2000 CMY inks) despite the lower coat weights yielded by flexography, relative to more conventional inkjet coating methods (for example, gravure). As a point of reference, the pigment to binder ratio of this coating is nearly four times greater than other comparative outdoor durable coatings.

### Binder

As used herein, “binder” refers to a polymeric material of varying composition that holds a filler or pigment together. The binder for this inkjet-receptive coating functions as the “glue” which holds the pigment or silica particles together and to the substrate surface. This binder can be, but is not limited to, an acrylic, polyurethane, PVA, or VAE, or any compatible combination.

The resins incorporated in the illustrated exemplary embodiments are PVA and VAE.

PVA is commonly used in inkjet coatings for its high cohesive strength and inherent ability to swell and absorb aqueous solutions (including inkjet inks) when in contact. The performance of PVA is mainly dictated by the grade of PVA selected, which is quantified by two properties: the degree of hydrolysis and the average molecular weight. Because PVA is created through the saponification/hydrolysis of polyvinyl acetate, residual acetyl functional groups remain on some molecules in any PVA solution or solids. The percentage of hydroxyl groups (also known as “percent hydrolysis”) can range from 87 mol % (partially-hydrolyzed) to 99 mol % (super-hydrolyzed). Similarly, the PVA chains can vary in the degree of polymerization, and therefore, molecular weight. The molecular weight of these solutions is measured as the viscosity (in mPa·s) of a 4% aqueous solution with increased viscosity corresponding to increased molecular weight. The grade of PVA selected impacts performance features of the final coating, including adhesion to the substrate (especially in regards to hydrophilic versus hydrophobic), cohesive strength, and porosity.

A solution of an 88 mol %-hydrolyzed-grade PVA with a 4%-aqueous-solution viscosity of 25 mPa·s (equivalent to −105,000 g/mol) was used in the example below—Selvol™ Polyvinyl Alcohol 09-523 Solution (available from Sekisui Specialty Chemicals America LLC of Dallas, TX). This particular grade of PVA provides appropriate adhesion to the polymeric substrates used in this disclosure and sufficient permeability to aqueous inkjet inks while limiting viscosity so as not to yield difficulty or unmanageable processability.

Variations in VAE copolymer come from the percentage of vinyl acetate relative to ethylene and any modified functional groups added to the backbone of the polymer chain. VAE copolymers impart additional mechanical stability, flexibility, and water-fastness to the coating while providing high solids content conducive to formulation with minimal decrease in viscosity. Vinnapas® EP 7000 (available from Wacker Chemical Corporation of Allentown, PA), which has a glass transition temperature (T g) of −3° C. and 71% solids, was the VAE selected for the exemplary coating in the example below. This particular resin may not be necessary for proper functioning of the finished product, but provides the additional benefits mentioned above.

VAE and PVA may be combined in various ratios to give a balance of properties. In the preferred example below, a 0.67:1 PVA:VAE ratio (based on dry parts binder) yielded a matrix that, when combined with a suitable pigment, had softness/flexibility, moderate adhesion to polymeric substrates, moderate cohesive strength, and acceptable print quality (for example, dry time, optical density, edge definition, and so forth).

While a binder is required for this coating to function—as it holds together the pigment—the binder does not necessarily have to be PVA and/or VAE. Additionally, either of these two binders could be excluded from the formula at a cost to their respective performance contributions, listed above. Different grades of these polymers could also potentially be used.

### Pigment to Binder Ratio

The pigment to binder ratio is the amount of dry parts pigment divided by the dry parts polymeric binder in an inkjet-receptive coating (i.e., the weight or mass ratio of the dry ingredients). The pigment to binder ratio may be varied within a range determined by the physical characteristics of the pigment (particle size, specific surface area, pigment volume concentration or PVC) and binder (cohesive strength). Reducing the pigment to binder ratio will provide improved adhesion to a polymeric substrate and better cohesive strength at the expense of ink-handling capacity. In comparison, increasing the pigment to binder ratio will improve ink-handling capacity at the expense of film strength. At the extremely high pigment to binder ratios, a cohesive film will not form, nor will the coating adhere to the substrate. Ideally, in the topcoat formulations for receiving color ink, the pigment to binder ratio will be optimized such that adhesion and film strength are optimized against ink-handling capacity, particularly in regards to a flexographic printing method.

The pigment to binder ratios by weight used in the exemplary embodiments in this disclosure is 4:1 by dry parts (again, that is, by weight or mass of the parts as dry prior to inclusion in the coating formulation). However, it is contemplated that the pigment to binder ratio could be more broadly in a range of from 3:1 to 5:1 by dry parts, or in a range of from 7:2 to 9:2 by dry parts. All such ratios are well above those found in conventional inkjet-receptive topcoat formulations.

Again, and as previously mentioned above, the pigment to binder ratio of this disclosed coating is much higher than traditional coatings or, put differently, the coating has much lower binder content relative to the pigment than other coatings. This lack of “glue” in the form of the binder tends to give the coating and, therefore, the finished label, a chalkier feel relative to other coatings. With enough force, the coating can even be rubbed off the label although this has not been observed in normal handling. Regardless, in many actual applications such as those in which the topcoat and printed material are further covered by a lamination layer as in a self-laminating article or “self-lam,” the potential problem of rub-off or wear due to chalkiness is completely eliminated because once the layer is covered by the clear film layer, the coating cannot be directly rubbed off.

### Optional Additives

A variety of additives can also be included in the inkjet-receptive layer to impart unique functionalities such as, for example: surfactants, anti-settling additives, optical brighteners, and so forth.

In some forms, a surfactant may be added as a processing aid. In some forms, the selection of the appropriate surfactant aids in foam release from the liquid coating formulation, which helps achieve a defect-free coating layer. In some forms, an appropriate surfactant may also aid in wetting of the polymeric substrate via reduction of the coating surface tension. Surfactants may be classed according to the composition of the hydrophilic head group; classes include, but are not limited to: anionic, cationic, amphoteric, and non-ionic. In some forms, the surfactant may be a non-ionic surfactant. Non-limiting examples of surfactant can include fatty alcohol ethoxylates, alkylphenol ethoxylates, fatty acid ethoxylates, ethoxylated amines, fatty acid amides, and sorbitol derivatives. Specialty non-ionic surfactants may include hydrophobic silica or fluorocarbons. The amount of surfactant in the coating may vary, but may be in the amount of from 0.01%, or 0.05%, or 0.1%, or 0.5%, or 1%, or 2% to 5%, or 7.5%, or 10%; or from 0.01% to 10%, or from 0.02% to 7.5%, or from 0.05% to 5%, based on the total weight of solids in the formulation from which the coating is made.

For example, the high-shear conditions or proper silica dispersion may dictate the use of a surfactant to aid in foam disruption and to prevent air from being entrained in the coating. Surfynol® 104 PA (acetylenic diol in solvent) (available from Evonik of Essen, Germany) was incorporated for this purpose (a substrate wetting additive) in the example below.

Additionally, and optionally, a mordant or cationic fixative can be incorporated into the inkjet-receptive coating. As used herein, a “mordant” is a substance used to set colorants (e.g., anionic pigments or dyes) on a substrate by forming a coordination complex with the colorant, which then attaches to the substrate. This fixative may be either a polymer (usually a quaternary amine) or a salt (mono- or polyvalent).

Polydiallyldimethyl-ammonium chloride (pDADMAC) is commonly used in the inkjet industry, and was used in the examples found in this disclosure. This mordant and cationic agent electrostatically binds to the anionic pigment particles in the printed inkjet ink, “locking” that pigment particle in place on the coating surface to yield a vivid, optically dense image with crisp, defined edges. The incorporation of a mordant or cationic fixative is optional but frequently advantageous, as the lack of such additive yields considerably poorer print quality. For example, and with reference being made to FIGS. 3A and 3B, the printed image quality without mordant included in topcoat (FIG. 3A) and with mordant included in topcoat (FIG. 3B) can be observed.

For settling and shelf-life stability reasons, the pigment to binder (P:B) ratio of this coating is once again of significance. The P:B used in the exemplary embodiments in this disclosure is 4:1; however, it is contemplated that the P:B ratio could be more broadly in a range of from 3:1 to 5:1, or in a range of from 7:2 to 9:2. All such ratios are well above those found in conventional inkjet-receptive topcoat formulations. The combination of a high Syloid® W 300 pigment/silica concentration (which has a specific gravity greater than 1.00) and minimal incorporation of resin (relative to traditional inkjet coatings) can create issues keeping the pigment suspended in solution, yielding poor shelf-life stability of the coating. To address such issues, an anti-settling additive can be included in the coating, such as CAB-O-SPERSE® PG 022 (available from Cabot Corporation of Boston, MA), a fumed silica dispersion. In low-shear environments, such as those generated by gravity during coating storage, this fumed silica additive creates networks surrounding the much larger precipitated silica particles (Syloid® W 300), electrosterically stabilizing the coating and preventing settling through hydrostatic pressure. Such fumed silica, when employed, is not included in the pigment to binder ratio calculations described herein. The particular properties of this fumed silica that make it viable and ideal for this application are its cationic surface charge/zeta potential and pre-dispersed nature.

Almost all of the raw materials used in this coating are acid-stabilized. As a result, a 10% hydrochloric acid solution can be added to the coating to maintain a pH between 3 and 4.

Optionally, an optical brightener can provide dual functionality to the coating in this product. Any fluorescent pigment that absorbs light in the ultraviolet (UV) region of the electromagnetic spectrum and emits in the visible region, while remaining compatible with the rest of the coating materials might serve this function. As one example, Tinopal® SFP (a triazine-stilbene) (available from BASF of Ludwigshafen, Germany) has been evaluated and shown to be viable for this coating.

Optionally, a primer/opacifying layer may or may not be coated to the substrate prior to coating the inkjet-receptive coating to provide a variety of functions including, but not limited to, increasing adhesion of the inkjet-receptive topcoat to the substrate or increasing opacity of the printable region of the substrate. This base layer can utilize a number of chemistries known to the art, including UV-curable (for example, methacrylates) or aqueous inks. This base layer is not essential for the coating, and therefore label, to function properly in terms of inkjet-receptivity, but may be useful to achieving the desired opacity for the particular label or application.

### Substrate

The substrate may be polymeric and may be prepared from a wide variety of polymers including, but not limited to, polyester, polyolefin, polyimide, polycarbonate, acrylic, and vinyl. Preferably, the substrate is prepared from either a polyester or vinyl, particularly a polyethylene terephthalate (PET) ester or a polyvinyl chloride (PVC). Most preferably, the substrate is prepared from a PET. The substrate is typically in the form of a film with a typical thickness of from 0.001 inches (in), or 0.002 in, or 0.004 in to 0.006 in, or 0.008 in, or 0.010 in, or 0.012 in; or from 0.001 to 0.012 in, or from 0.002 to 0.010 in, or from 0.003 to 0.007 in, or from 0.004 to 0.06 in.

It is contemplated in some forms that the substrate could be instead, but is not so limited to, woven or non-woven fabrics.

The substrate contacts the topcoat. As used herein, the term “contact” refers to direct contact and “Indirect contact.” “Direct contact” refers to a layer configuration whereby a first layer is located immediately adjacent to a second layer and no intervening layers or no intervening structures are present between the first layer and the second layer. “Indirect contact” refers to a layer configuration whereby a first layer is located adjacent to a second layer and at least one intervening layer or intervening structure is present between the first layer and the second layer.

### Adhesive

The substrate may also support an adhesive in some forms. The composition of the adhesive—if an adhesive is present in the article as would be the case if the article was an adhesive-based label and/or a self-laminating label, for example—can vary widely and includes, but is not limited to, materials comprising acrylic, rubber hybrid acrylic, and rubber pressure sensitive adhesives. Thermosetting polyester or polyurethane adhesives may be used. In some forms, the adhesive may be a pressure sensitive adhesive (PSA). The thickness of the adhesive layer may be in the range of from 0.0005 in, or 0.0007 in, or 0.0009 in, or 0.0012 in, or 0.0015 in to 0.002 in, or 0.0025 in, or 0.003 in; or from 0.0005 to 0.003 in, from 0.0007 in to 0.0025 in, or from 0.0009 in to 0.002 in.

If present, the adhesive layer can be attached to the substrate and may provide a way of fastening the inkjet-receptive article to the surface of another object or, in some cases, the article to itself to form a loop or other shape and potentially to provide a secured lamination layer.

### Liner

If an adhesive layer is present in the article, the bottom of the adhesive layer may be in contact with or covered by the release liner. The composition of the release liner can vary widely, and is typically silicone coated to protect the adhesive until it is applied to another object, and to carry the label through a printer. Non-limiting examples of the release liner can be a film type or a coated paper (e.g., a silicone-coated paper), which gives the adhesive a smooth surface which minimizes entrapped air when bonded to the end-use surface. The release liner may be optional to the overall construction and may be absent in embodiments in which no adhesive layer is present. However, in cases in which the article is being printed upon and fed through a printer, the initial covering of any adhesive by a liner will permit the article to be fed through the printer without sticking to rollers, example.

### Print Layer

As noted elsewhere, the article is ultimately designed to receive a print layer and, in particular a color ink jet layer which may be considered part of the article after printing. In some forms, the facial surface of the inkjet-receptive coating may be in contact with the facial surface of a print layer to the extent that the print layer is not already integrated with or received by the coating layer.

The composition of the printing layer may be aqueous pigment ink, that is a water-based ink comprising pigments, one or more polymers, and one or more additives, all of which adhere to the substrate upon drying. It is understood that the pigment contained in the aqueous pigment-based ink in the printing layer is different than the pigment contained in the topcoat.

Aqueous pigment-based inks are widely available commercially; representative non-limiting examples of suppliers include Funai, HP, Kodak, and Ricoh. As noted above, the print layer can include, in view of the novel composition of the topcoat, color inks although the topcoat is flexographically printed.

It is contemplated that in most use cases, the article will be provided to the end user without a print layer already printed thereon, such that the end user will print the print layer on the article using an inkjet printer. However, it is also contemplated that, in some cases, the article could be printed upon prior to sale to the end user or by a third party, such that the end user does not need to perform their own printing.

In an embodiment, an article is provided. The article contains, consists essentially of, or consists of:
(A) a substrate
(B) a flexographically-printed full-color-inkjet receptive topcoat that is flexographically applied on a side of the substrate, the flexographically-printed full-color-inkjet receptive topcoat containing, consisting essentially of, or consisting of
   i. a pigment
   ii. a polymeric binder
   iii. optionally, one or more additives
   wherein a ratio of the pigment to polymeric binder is in a range of from 3:1 to 5:1, or from 7:2 to 9:2, or is 4:1 by dry parts; and
   the article optionally has one, some, or all of the following properties:
a) the substrate includes a material selected from a polyester, a polyolefin, a polyimide, a polycarbonate, an acrylic, a vinyl, and combinations thereof; and/or
b) the substrate includes a material selected from PET, PVC, and combinations thereof; and/or
c) the substrate is selected from a film, a woven fabric, or a non-woven fabric;
d) the substrate has a thickness of from 0.001 in to 0.012 in; and/or
e) the pigment is selected from carbonate, kaolin, silica, titanium dioxide, silicates, and combinations thereof; and/or
f) the pigment is a silica selected from colloidal silica, fumed silica, precipitated silica, and combinations thereof; and/or
g) the pigment is precipitated silica; and/or
h) the pigment has a primary particle size of from 0.1 μm to 10 μm, or from 1 μm to 10 μm, or from 5 μm to 10 μm, or from 5 μm to 9 μm; and/or
i) the pigment has a specific surface area of from 150 m²/g to 750 m²/g, or from 150 m²/g to 500 m²/g, or from 250 m²/g to 500 m²/g, or from 250 m²/g to 400 m²/g; and/or
j) the pigment is precipitated silica having a specific gravity greater than 1.00; and/or
k) the polymeric binder is selected from an acrylic, a polyurethane, PVA, VAE, or a combination thereof; and/or
l) the polymeric binder is selected from VAE, PVA, or a combination thereof; and/or
m) the polymeric binder includes a PVA having a percent hydrolysis of from 87 mol % to 99 mol %, or from 87 mol % to 90 mol %; and/or
n) the polymeric binder includes a PVA having a 4%-aqueous-solution viscosity of 25 mPa·s and a percent hydrolysis of 88 mol %; and/or
o) the polymeric binder includes PVA and VAE at a ratio of 0.67:1 PVA:VAE, based on dry parts binder; and/or
p) the optional additive is selected from a surfactant, an anti-settling additive, an optical brightener, a mordant, a cationic fixative, or a combination thereof; and/or
q) the topcoat is applied to the substrate in an amount from greater than 0 lb/ream (0 GSM) to less than 2.5 lb/ream (4.07 GSM), or from greater than 0 lb/ream (0 GSM) to 1 lb/ream (1.628 GSM).

### Method of Making

As outlined above, the article is to be prepared using flexographic printing of the topcoat.

In one non-limiting exemplary method, the substrate may be first prepared in any conventional manner. For example, a polymeric film may be cast or extruded, in one or more multiple layers from one or more polymeric resins, e.g. PVC. The substrates may be typically commercially available films. In some forms another layer may be formed with or applied to the substrate prior to the application of the topcoat (such as, for example, an opaque base layer to provide better contrast for any subsequent printing).

The film or substrate may be then covered or coated with the printable topcoat on a facial side thereof by a flexographic printing step. It is contemplated in some forms that the topcoat layer might be applied by one or more flexographic printing steps, as the amount of topcoat material transferred is relatively low using flexographic transfer. The application of the coating is usually, but not necessarily followed by a heat drying/curing process, e.g. exposure to a temperature of from 50° F. (10° C.) to 300° F. (149° C.) for flexographically-applied coatings. Exposure time is fairly short typically not exceeding 1 minute.

The topcoat is flexographically-applied in an amount of from greater than 0 lb/ream (0 GSM) to less than 2.5 lb/ream (4.07 GSM), or from greater than 0 lb/ream (0 GSM) to 1 lb/ream (1.628 GSM).

In an embodiment, the topcoat layer is formed by flexographically-applying a topcoat composition to a facial side of the substrate, and optionally exposing the coated substrate to a temperature of from 10° C. to 149° C. for up to 1 minute. In some forms, the topcoat composition contains, consists essentially of, or consists of:
(A) a pigment;
(B) a polymeric binder; and
(C) optionally, one or more additives;

wherein a ratio of the pigment to polymeric binder is in a range of from 3:1 to 5:1, or from 7:2 to 9:2, or is 4:1 by dry parts; and

optionally, the topcoat composition has a pH of from 1 to 6, or from 3 to 4.

In some forms, an adhesive may be applied in any conventional manner to the opposite facial surface of the film. A liner may then be applied to the exposed surface of the adhesive layer. If the article does not comprise an adhesive, then these two steps may be eliminated. In at least some forms of the method, the adhesive and liner can be applied prior to the application of the topcoat to the substrate.

Many variations exist on this illustrative method of preparing the label construction. In a non-limiting example, the two or more of the described steps can be reversed or otherwise changed in sequence. Likewise, depending on the particular construction of the article, entire side or partial sides may be coated with the topcoat and/or the adhesive.

Subsequent to forming the article, a printed image or another form of indicia may be printed onto the ink-receptive coating to provide the final printed article using an inkjet printer. Again, the benefit of using the topcoat composition described above and herein is that it can receive color inkjet printing despite having a flexographically printed topcoat. Non-limiting examples of indicia include texts, characters, forms, signage, visual graphics, pictures, photos, lines, and combinations thereof.

In an embodiment, an article is provided. The article contains, consists essentially of, or consists of:
(A) a liner layer;
(B) an adhesive layer;
(C) a polymeric substrate;
(D) an opaque layer;
(E) a flexographically-applied full-color-inkjet receptive topcoat layer; and
(F) optionally, a full-color inkjet-printed layer;

wherein the article has an A/B/C/D/E/F configuration, whereby each layer directly contacts the adjacent layer;

wherein the topcoat layer contains, consists essentially of, or consists of
i. a pigment
ii. a polymeric binder
iii. optionally, one or more additives

wherein a ratio of the pigment to polymeric binder in the topcoat layer is in a range of from 3:1 to 5:1, or from 7:2 to 9:2, or is 4:1 by dry parts; and

the article optionally has one, some, or all of the following properties:
a) the adhesive layer includes an adhesive selected from acrylic adhesives, rubber hybrid acrylic adhesives, rubber pressure sensitive adhesives, thermosetting polyester adhesives, thermosetting polyurethane adhesives, and combinations thereof; and/or
b) the adhesive layer comprises a PSA; and/or
c) the adhesive layer has a thickness of from 0.0005 in to 0.003 in, or from 0.0005 in to 0.0025 in, or from 0.0005 in to 0.002 in; and/or
d) the adhesive layer is a continuous layer extending across an entire surface (or side) of the substrate; and/or
e) the substrate includes a material selected from a polyester, a polyolefin, a polyimide, a polycarbonate, an acrylic, a vinyl, and combinations thereof; and/or
f) the substrate includes a material selected from PET, PVC, and combinations thereof; and/or
g) the substrate is selected from a film, a woven fabric, or a non-woven fabric;
h) the substrate has a thickness of from 0.001 in to 0.012 in, or from 0.001 in to 0.010 in, or from 0.001 in to 0.007 in, or from in to 0.06 in; and/or
i) the pigment is selected from carbonate, kaolin, silica, titanium dioxide, silicates, and combinations thereof; and/or
j) the pigment is a silica selected from colloidal silica, fumed silica, precipitated silica, and combinations thereof; and/or
k) the pigment is precipitated silica; and/or
l) the pigment has a primary particle size of from 0.1 μm to 10 μm, or from 1 μm to 10 μm, or from 5 μm to 10 μm, or from 5 μm to 9 μm; and/or
m) the pigment has a specific surface area of from 150 m²/g to 750 m²/g, or from 150 m²/g to 500 m²/g, or from 250 m²/g to 500 m²/g, or from 250 m²/g to 400 m²/g; and/or
n) the pigment is precipitated silica having a specific gravity greater than 1.00; and/or
o) the polymeric binder is selected from an acrylic, a polyurethane, PVA, VAE, or a combination thereof; and/or p) the polymeric binder is selected from VAE, PVA, or a combination thereof; and/or
q) the polymeric binder includes a PVA having a percent hydrolysis of from 87 mol % to 99 mol %, or from 87 mol % to 90 mol %; and/or
r) the polymeric binder includes a PVA having a 4%-aqueous-solution viscosity of 25 mPa·s and a percent hydrolysis of 88 mol %; and/or
s) the polymeric binder includes PVA and VAE at a ratio of 0.67:1 PVA:VAE, based on dry parts binder; and/or
t) the optional additive is selected from a surfactant, an anti-settling additive, an optical brightener, a mordant, a cationic fixative, hydrochloric acid, or a combination thereof; and/or
u) the topcoat is present in an amount of from greater than 0 lb/ream (0 GSM) to less than 2.5 lb/ream (4.07 GSM), or from greater than 0 lb/ream (0 GSM) to 1 lb/ream (1.628 GSM); and/or
v) the topcoat has a microporous structure;
w) the liner is removable; and/or
x) the full-color inkjet-printed layer includes one or more indicia; and/or
y) the full-color inkjet-printed layer is formed from an aqueous cyan-magenta-yellow inkset; and/or
z) the opaque layer is white; and/or
aa) the opaque layer is ultraviolet-curable; and/or
bb) the article is a self-laminating marker including (i) a head end having the A/B/C/D/E/F configuration and (ii) a tail end that is transparent and is formed from the polymeric substrate, the adhesive layer, and optionally, the liner layer, the tail end having an A/B/C configuration, whereby each layer directly contacts the adjacent layer, wherein the tail end is sized to wrap around an object and cover all, or substantially all, of the head end.

Now, with the general continent materials having been described, some general exemplary topcoat compositions and exemplary articles formed using the topcoat are provided.

### Example 1: Topcoat Composition

In one preferred form, the flexographically-printed, full-color-inkjet receptive topcoat, has a coating composition as listed in Table 1 below:

TABLE 1

| Coating ingredient | Wt % |
|---|---|
| Deionized water | 22.90% |
| pDADMAC, 35% solution (mordant) | 4.42% |
| Surfynol ® 104PA (surfactant) | 0.14% |
| CAB-O-SPERSE ® PG 022 | 3.32% |
| (anti-settling agent, fumed silica dispersion) | |
| Syloid ® W 300 (pigment) | 41.78% |
| Vinnapas ® EP 7000 (binder, VAE) | 4.19% |
| Selvol ™ 09-523 (binder, PVA) | 22.05% |
| Hydrochloric acid, 10% solution | 1.00% |
| Tinopal ® SFP (optical brightener) | 0.20% |
| Total | 100.00% |

For the sake of clarity, the pigment to binder ratio is calculated based on dry weight or mass left in the topcoat, but the values in Table 1 above are not dry weight percent. For example, the pDADMAC mordant is only 35% solids, so only 35% of the 4.42% listed above would be left in the dry topcoat. Neither of the binders nor the Syloid® W 300 silica are 100% solids, so the pigment to binder ratio is not directly calculable from Table 1 above, which only lists the initial ingredients of the coating before the coating has dried. The pigment to binder ratio by weight used in this exemplary embodiment is 4:1 by dry parts (by weight or mass of the parts as dry prior to inclusion in the coating formulation). The PVA:VAE ratio used in this exemplary embodiment is 0.67:1 (based on dry parts binder). The coating composition has a pH of 2-3.

### Example 2: Layer Structure for an Adhesive Label and Self-Lam

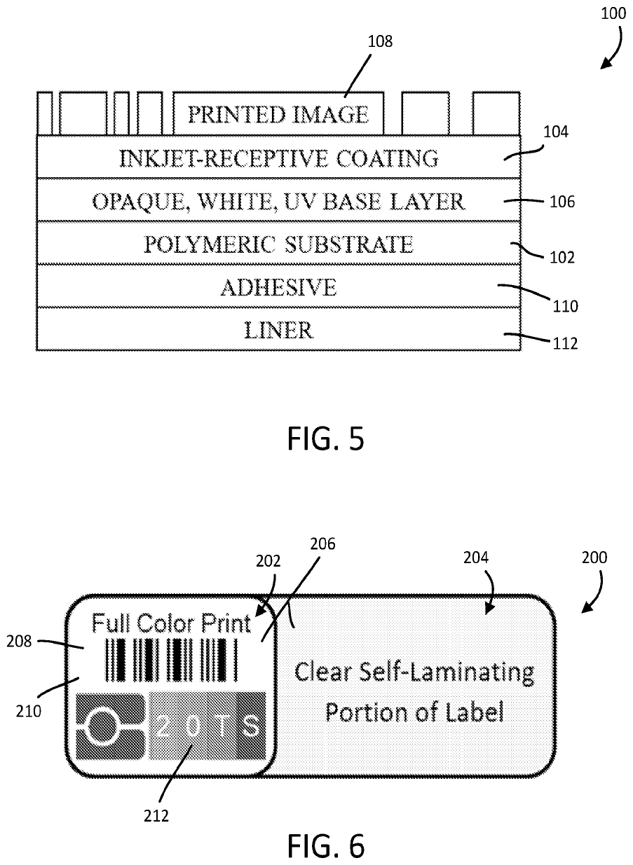

A topcoat formulation such as that described above can be flexographically-applied to a substrate material as described in the method above. Such a layer structure as is illustrated in FIG. 5 can result from this production method.

FIG. 5 depicts a schematic drawing of an article 100 including a polymeric substrate 102 which has an ink-receptive coating layer 104 (i.e., the flexographically-applied, color-inkjet-receptive topcoat) on one side thereof as well as an opaque, UV base layer 106 between one facial side of the substrate 102 and the ink-receptive coating layer 104. Although it is not initially part of the article 100, a print layer 108 can be printed on top of the coating layer 104 to present indicia such as text and/or images. It is noted that although this print layer 108 is depicted as a separate layer from the coating layer 104, in actuality, the ink from the printing process will enter the coating layer 104 and so the layers 104 and 108 are not as discrete as they appear in the schematic and, in fact, are for the most part overlapping. In the particular article 100 illustrated, on the side of the polymeric substrate 102 opposite the coating layer 104, the polymeric substrate 102 supports an adhesive layer 110 which is initially covered by a release liner 112. In use, the liner 112 may be removed to expose the adhesive layer 110 and the adhesive layer 110 may be used to affix the article to a surface (or to the article 100 itself, in the case of a self-lam, for example).

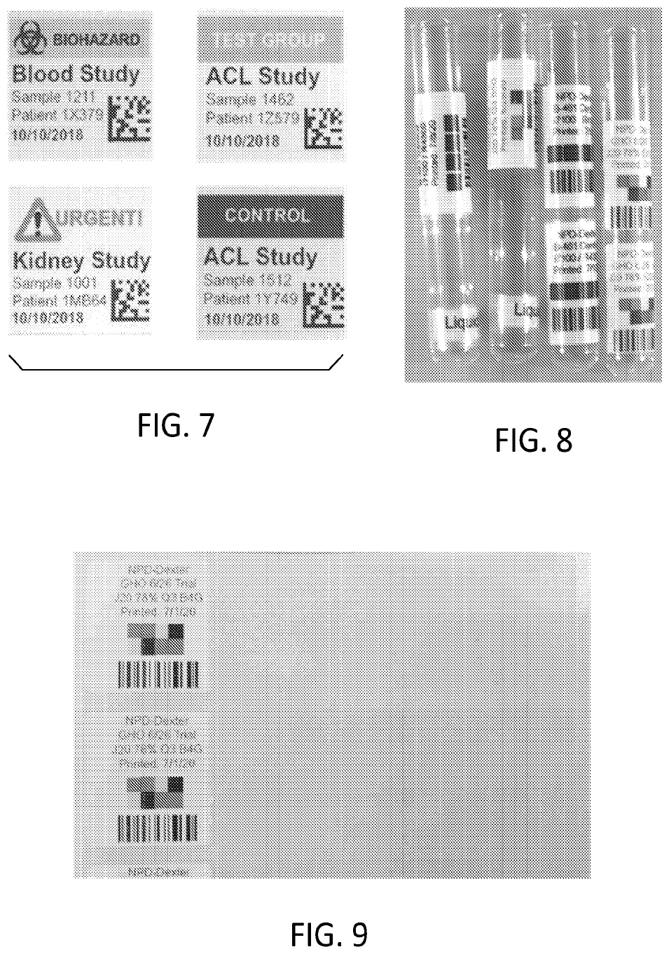

In general application, the article 100 could be, for example, an adhesive label that has been printed on with pigment-based ink to form the print layer 108. The article 100 may be printed on using a small-format inkjet printer (although is not necessarily so limited to that specific type of printing, but is well adapted for it). Such exemplary printed labels are illustrated in FIG. 7, for example, which may be affixed to test tubes containing patient samples.

Turning now to FIG. 6, FIG. 6 depicts a schematic of an article 200 in the form of a self-laminating label which also incorporates this new topcoat composition. Generally speaking, the article includes a printable portion 202 or head end and a laminating portion 204 or tail end. In the form illustrated, a polymeric substrate 206 covers the entire area with the printable portion 202 being further defined as a region of the substrate 206 receiving an opaque layer 208 upon which the inkjet-receptive coating 210 is flexograpically applied. Again, the inkjet-receptive coating 210 can have a full color print layer 212 printed upon it by an inkjet printer after the article 200 is initially formed. The laminating portion 204 is a clear or transparent film that extends from one side of the printable portion 202 and that is effectively the continued portion of the clear substrate 206 without an opaque layer 208 or the inkjet-receptive coating 210 received thereupon. On the backside of the article 200, an adhesive is present as well as a release liner (with neither being shown in FIG. 6). After printing, the release liner can be removed and the article 200 wrapped around an object with the adhesive side facing the object and the printable portion 202 being first wrapped around the object until the laminating portion 204 wraps back around to cover and adhere to the printable portion 202 (which is visible through the laminating portion 204 as both the substrate 206 and adhesive are substantially transparent). As there is an adhesive on the back side, this means that the adhesive on the back side of the laminating portion 204 can be used to secure the laminating portion 204 over the printable portion 202 to overlay and protect the print layer 212 and coating 210 (to the extent that such coating may be chalky and subject to wearing or rubbing). In this way, the article 200 is self-laminating in that it can laminate itself upon application.

Looking now at FIGS. 8 and 9, such self-laminating labels are depicted in sheet form after printing (FIG. 9) and after being wrapped around test tubes (FIG. 8) such that the laminating portion covers the printable area to prevent the print layer and topcoat from wear or exposure to fluids, for example. The printable portion 202 of the self-laminating labels depicted in FIG. 9 (after printing) have the composition and structure described in Table 2.

TABLE 2

| Layer | Material | Thickness |
|---|---|---|
| Full Color Print Layer (212) | Full Color Inkjet Ink | N/A |
| Flexograpically-Applied Inkjet- | Coating Composition | N/A |
| Receptive Coating (210) | of Table 1 | |
| Opaque Layer (208) | White Flexography Ink | 12.7 μm |
| Clear Polymeric Substrate (206) | PET | 25.4 μm |
| Adhesive | PSA | 12.7 μm |
| Liner | Silicone-Coated Paper | 88.9 μm |

It is understood that in Table 2, the liner layer directly contacts the adhesive layer, which directly contacts the clear polymeric substrate layer 206, which directly contacts the opaque layer 208, which directly contacts the flexograpically-applied inkjet-receptive coating layer 210, which directly contacts the full color print layer 212. The liner layer is removed before the article is adhered to and wrapped around the test tubes.

The flexograpically-applied inkjet-receptive coating layer 210 is applied in an amount of greater than 0 lb/ream (0 GSM) and less than 2.5 lb/ream (4.07 GSM).

The printable portion 202 of the self-laminating labels depicted in FIG. 9 (after printing) is 1 in (2.54 cm)×1 in (2.54 cm), and the laminating portion 204 is 1 in (2.54 cm)×1.625 in (4.1275 cm).

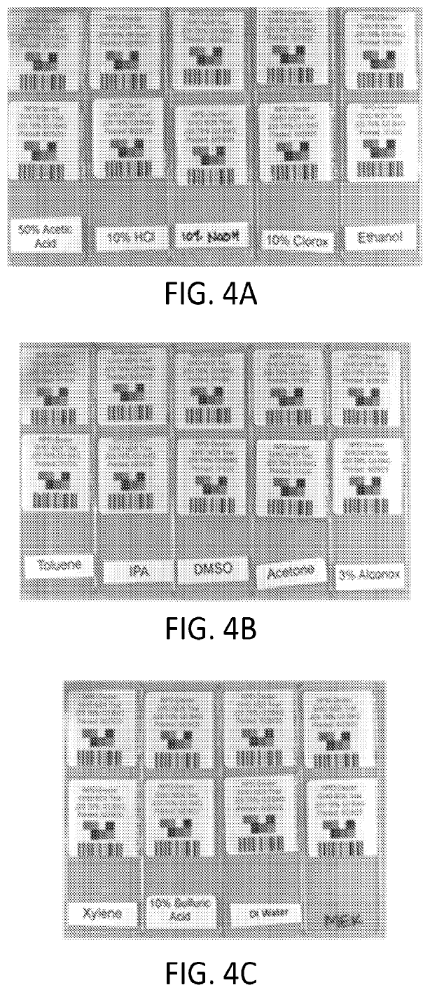

While the inkjet-receptive topcoat determines print quality (that is, dry time of the printed ink, amount of inter-color bleed, and so forth), ultimately the self-laminating feature of this label helps to provide performance/functioning in regards to physical testing attributes (such as chemical resistance, abrasion, and so forth). During chemical testing, for example, the PET self-lam wrap will not be affected by rubbing with or immersion in even the harshest chemicals, and the printed image will be safely secured/protected under a layer of substrate and adhesive. Prepared labels after chemical immersion and rubs can be found in FIG. 4A-C which identify various chemical exposures.

While two example articles have been illustrated, it will be appreciated that these are only exemplary and variations could be made. For example, not all of the surfaces of the substrate need to be coated with the coating layer and/or the adhesive (if an adhesive is indeed present) and entire or only fractional portions of the surfaces might be covered. Moreover, nothing specifically requires that the coating layer and/or adhesive to be on one side or to be on opposite sides from one another. It will be readily appreciated that both sides may have the ink-receptive coating layer and/or the application of that coating layer to a side may be fractional or partial in nature. The same is likewise true for the adhesive layer and/or liner. In this way, it is contemplated that various more complex structures could be formed such as articles which may be two-side printed and/or articles in which loops or other structures may be formed for attachment to objects.

### Test Methods

Primary particle size is measured in accordance with the GRACE 498000 test method, utilizing a Malvern Mastersizer 2000.

Specific surface area is measured in accordance with ASTM C 1274-12. Specific surface area is also referred to as Brunauer-Emmett-Teller (BET) surface area.

Unless stated to the contrary, implicit from the context, or customary in the art, all parts and percents are based on weight and all test methods are current as of the filing date of this disclosure.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto.

Various features and advantages of the invention are set forth in the following claims.

We claim:

1. An article with a flexographically-printed, full-color-inkjet receptive topcoat, the article comprising:
a substrate;
a flexographically-printed, full-color-inkjet receptive topcoat that is flexographically applied on a side of the substrate, the flexographically-printed, full-color-inkjet receptive topcoat comprising a pigment and a polymeric binder in which a ratio of the pigment to polymeric binder is in a range of from 3:1 to 5:1 by dry parts.

2. The article of claim 1, wherein the ratio of the pigment to polymeric binder is in a range of from 7:2 to 9:2 by dry parts.

3. The article of claim 1, wherein the ratio of the pigment to polymeric binder is 4:1 by dry parts.

4. The article of claim 1, wherein a side of the substrate has an adhesive layer received thereon which is opposite the side of the substrate on which the flexographically-printed, full-color-inkjet receptive topcoat is flexographically applied.

5. The article of claim 4, further comprising a liner covering the adhesive.

6. The article of claim 1, wherein the article further includes a printed image in color ink thereon printed by an inkjet printer.

7. The article of claim 1, further comprising an opaque white base layer on the side of the substrate between the substrate and the flexographically-printed, full-color-inkjet receptive topcoat.

8. The article of claim 1, wherein the flexographically-printed, full-color-inkjet receptive topcoat includes one or more additives that is/are a surfactant, an anti-settling additive, and/or an optical brightener.

9. The article of claim 1, further comprising a mordant in the flexographically-printed, full-color-inkjet receptive topcoat.

10. The article of claim 1, wherein the binder comprises a blend of vinyl-acetate ethylene copolymer and polyvinyl alcohol.

11. The article of claim 1, wherein the pigment is selected from the group consisting of carbonate, kaolin, silica, titanium dioxide, silicates, and combinations thereof.

12. The article of claim 11, wherein the pigment has primary particle sizes ranging from 100 nanometers to 10 micrometers and specific surface areas of from 150 m²/g to 750 m²/g, as measured in accordance with ASTM C 1274-12.

13. The article of claim 1, wherein the substrate is a polymeric substrate.

14. The article of claim 1, wherein the flexographically-printed, full-color-inkjet receptive topcoat is applied to the substrate in an amount less than 2.5 lb/ream.

15. The article of claim 1, wherein the article is a self-laminating marker having a head end with a printable area and a tail end which is transparent, in which the flexographically-printed, full-color-inkjet receptive topcoat is provided on at least on the printable area and wherein the article further comprises an adhesive layer received on a side of the substrate opposite the side on which the flexographically-printed, full-color-inkjet receptive topcoat is flexographically applied such that, during application of the self-laminating marker around an object by wrapping, the head end is first wrapped around the object until the tail end wraps back around to adhere to the self-laminating marker to itself to cover the printable area and protect the underlying printable area and any indicia or printing received thereon.

16. A method of making an article, the method comprising:
flexographically printing a full-color-inkjet receptive topcoat onto a side of a substrate in which the full-color-inkjet receptive topcoat comprises a pigment and a polymeric binder in which a ratio of the pigment to polymeric binder is in a range of from 3:1 to 5:1 by dry parts.

17. The method of claim 16, wherein the flexographically-printed, full-color-inkjet receptive topcoat is printed on the substrate in an amount less than 2.5 lb/ream.

18. A flexographically-printable, full-color-inkjet receptive topcoat for flexographic application on a side of a substrate, the flexographically-printable, full-color-inkjet receptive topcoat comprising:
a pigment and a polymeric binder in which a ratio of the pigment to polymeric binder is in a range of from 3:1 to 5:1 by dry parts.

19. The flexographically-printable, full-color-inkjet receptive topcoat of claim 18, wherein the ratio of the pigment to polymeric binder is in a range of from 7:2 to 9:2 by dry parts.

20. The flexographically-printable, full-color-inkjet receptive topcoat of claim 18, wherein the ratio of the pigment to polymeric binder is 4:1 by dry parts.

21. The flexographically-printable, full-color-inkjet receptive topcoat of claim 18, further comprising one or more additives that is/are a surfactant, an anti-settling additive, and/or an optical brightener.

22. The flexographically-printable, full-color-inkjet receptive topcoat of claim 18, further comprising a mordant in the flexographically-printable, full-color-inkjet receptive topcoat.

23. The flexographically-printable, full-color-inkjet receptive topcoat of claim 18, wherein the binder comprises a blend of vinyl-acetate ethylene copolymer and polyvinyl alcohol.

24. The flexographically-printable, full-color-inkjet receptive topcoat of claim 18, wherein the pigment is selected from the group consisting of carbonate, kaolin, silica, titanium dioxide, silicates, and combinations thereof.

25. The flexographically-printable, full-color-inkjet receptive topcoat of claim 24, wherein the pigment has primary particle sizes ranging from 100 nanometers to 10 micrometers and specific surface areas of from 150 m²/g to 750 m²/g, as measured in accordance with ASTM C 1274-12.

26. A method of printing onto an article of claim 1, the method comprising:
printing a color ink onto the flexographically-printed, full-color-inkjet receptive topcoat using an inkjet printer.
